(19) United States
(12) Patent Application Publication
(10) Pub. No.: US 2026/0186360 A1
(43) Pub. Date: Jul. 2, 2026

(54) DISPLAY APPARATUS AND METHOD OF MANUFACTURING LIQUID CRYSTAL DISPLAY PANEL

(71) Applicant: LG Display Co., Ltd., Seoul (KR)

(72) Inventors: Dae Hyun NAM, Paju-si (KR); Hyung Beom SHIN, Paju-si (KR); Se Eung LEE, Paju-si (KR); Seong Jun CHO, Paju-si (KR); Chan Ho LEE, Paju-si (KR)

(73) Assignee: LG Display Co., Ltd., Seoul (KR)

(21) Appl. No.: 19/329,033

(22) Filed: Sep. 15, 2025

(30) Foreign Application Priority Data
Dec. 30, 2024 (KR) 10-2024-0200833

(51) Int. Cl. G02F 1/1362; G02F 1/133

(52) U.S. Cl. CPC G02F 1/136295; G02F 1/13318

(57) ABSTRACT

Disclosed are a display apparatus and a method of manufacturing the liquid crystal display panel, configured to improve the transmittance of a sensing area and thereby increasing the recognition rate of an optical device. The display apparatus includes a liquid crystal display panel having an active area defined by a plurality of pixel areas formed by overlapping gate lines and data lines, and a bezel area located outside the active area. A sensing area is located within the active area and overlaps an optical device disposed below the panel. A backlight unit is positioned beneath the liquid crystal display panel. In the active area excluding the sensing area, the data lines include a metal material, while in the sensing area, the data lines include a transparent conductive material, thereby improving optical transmittance through the sensing area without requiring additional mask processes during fabrication.

### CROSS-REFERENCE TO PRIORITY APPLICATION(S)

This application claims the benefit of Korean Patent Application No. 10-2024-0200833, filed on Dec. 30, 2024, which is hereby incorporated by reference as if fully set forth herein.

### BACKGROUND

### Technical Field

The present disclosure relates to a display apparatus with an optical device located below a liquid crystal display panel and a method of manufacturing a liquid crystal display panel having a sensing area.

### Description of the Related Art

Typically, a display apparatus provides images to the user. For example, the display apparatus may include a backlight unit and a liquid crystal display panel that generates an image using light supplied from the backlight unit. The backlight unit may include a backlight light source device located on one side of a backlight light guide plate. The liquid crystal display panel may be located on the backlight light guide plate.

The display apparatus may include an optical device configured to detect external light or capture an image. The optical device may overlap some areas of the liquid crystal display panel. The liquid crystal display panel may include an active area overlapping the light guide plate and a sensing area supplying external light to the optical device.

The sensing area may be disposed in the active area. In addition, a polarizing plate, a liquid crystal layer, a color filter layer, etc., are present in the sensing area of the liquid crystal display panel.

### BRIEF SUMMARY

It has been observed that the presence of a polarizing plate, a liquid crystal layer, and a color filter layer in the sensing area of a liquid crystal display panel may reduce the transmittance of incident light to an underlying optical device. This reduction in transmittance can result in decreased recognition accuracy of the optical device. The present disclosure is directed to addressing such limitations associated with conventional display configurations.

In particular, the present disclosure relates to a display apparatus configured to improve optical transmittance in a sensing area of a display panel (e.g., liquid crystal display panel). In this structure, the data lines in the sensing area are formed using a transparent conductive material such as ITO (indium tin oxide) or IZO (indium zinc oxide), rather than a conventional opaque metal. To address the relatively high resistance of the transparent material, metal segments are locally applied only at regions where the data lines intersect gate lines. These metal segments may be formed directly on the transparent lines or on a separate layer with electrical connection, thereby maintaining low resistance without significantly obstructing light transmission.

Additional improvement in transmittance is achieved by eliminating the black matrix in most portions of the sensing area, while retaining the black matrix only at gate and data line intersections if needed. Moreover, the color filters in the sensing area are arranged such that the ends of adjacent filters do not overlap, thereby reducing unnecessary attenuation of transmitted light. These modifications enable external light to reach an optical device disposed below the display panel, such as a camera or infrared sensor, with higher efficiency compared to conventional display configurations.

The described structure is compatible with existing manufacturing processes. A single photolithography step using a halftone mask allows concurrent patterning of both transparent and metal materials without requiring additional masks. Resistance of the transparent data lines is further controlled by increasing their line width specifically in the sensing area, allowing stable signal delivery while maintaining optical transparency. This combination of structural and process features enables improved sensing performance through the liquid crystal panel without added fabrication complexity.

Various embodiments of the present disclosure provide a display apparatus capable of improving the transmittance of a sensing area of a liquid crystal display panel and thereby increasing the recognition rate of an optical device.

Various embodiments of the present disclosure provide a method of manufacturing a liquid crystal display panel for improving the transmittance of a sensing area.

The problems to be solved by the present disclosure are not limited to the foregoing. Any problems not mentioned herein will be apparent to those skilled in the art from the description below.

In order to accomplish the above technical benefits, a display apparatus according to the present disclosure may include a liquid crystal display panel including an active area in which a plurality of pixel areas is defined by a plurality of gate lines and a plurality of data lines intersecting each other and a bezel area located outside the active area, in which the active area has a sensing area.

A backlight unit located below the liquid crystal display panel and an optical device configured to sense external light passing through the sensing area of the liquid crystal display panel or capture an image may be included.

Here, the data lines disposed in the active area excluding the sensing area may include a metal material, and the data lines disposed in the sensing area may include a transparent conductive material.

In addition, a method of manufacturing a liquid crystal display panel including an active area in which a plurality of pixel areas is defined by a plurality of gate lines and a plurality of data lines intersecting each other and a bezel area located outside the active area, in which the active area has a sensing area, according to the present disclosure may include forming a gate line including a gate electrode on a substrate in the sensing area, forming a gate insulating film on the substrate including the gate line, forming a semiconductor pattern on the gate insulating film on the gate electrode, and forming a first data line using a conductive material on the gate insulating film in a direction intersecting the gate line and a second data line using a metal material so as to be in contact with the first data line in an area wherein the first data line intersects the gate line.

In addition, a method of manufacturing a liquid crystal display panel including an active area in which a plurality of pixel areas is defined by a plurality of gate lines and a plurality of data lines intersecting each other and a bezel area located outside the active area, in which the active area has a sensing area, according to the present disclosure may include forming a gate line including a gate electrode extending in a first direction on a substrate in the sensing area and a plurality of first data lines using a conductive material in a direction intersecting the gate line in the sensing area, forming a gate insulating film on the substrate including the gate line and the first data lines, forming a semiconductor pattern on the gate insulating film on the gate electrode, and forming a second data line using a metal material on the gate insulating film in a direction intersecting the gate line so as to electrically connect the adjacent first data lines.

Specific details of other embodiments are included in the detailed description and drawings.

### BRIEF DESCRIPTION OF THE SEVERAL VIEWS OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 schematically shows a display apparatus according to an embodiment of the present disclosure;

FIG. 2 is a cross-sectional view taken along lines I-I′ and II-II′ of FIG. 1;

FIG. 3 shows a circuit of a pixel area located in a liquid crystal display panel in the display apparatus according to an embodiment of the present disclosure;

FIG. 4 is a cross-sectional view of a pixel area PA in the active area AA rather than the sensing area;

FIG. 5 is a plan view of pixel areas disposed in an active area of a liquid crystal display panel according to an embodiment of the present disclosure;

FIG. 6 is a cross-sectional view taken along line III-III′ of FIG. 5;

FIG. 7 is a cross-sectional view taken along line IV-IV′ of FIG. 5;

FIG. 8 is a plan view of pixel areas disposed in a sensing area HA of the liquid crystal display panel according to an embodiment of the present disclosure;

FIG. 9 is a cross-sectional view taken along line III-III′ of FIG. 8;

FIG. 10 is a cross-sectional view taken along line IV-IV′ of FIG. 8;

FIG. 11 is a cross-sectional view taken along line IV-IV′ of FIG. 8 according to another embodiment of the present disclosure;

FIGS. 12A to 12G are cross-sectional views of a process of forming data lines DL in the sensing area HA of the liquid crystal display panel according to an embodiment of the present disclosure described in FIGS. 8 to 10;

FIGS. 13A to 13G are cross-sectional views of a process of forming data lines DL in the sensing area HA of the liquid crystal display panel according to another embodiment of the present disclosure described in FIG. 11; and

FIG. 14 is a graph showing the resistance of data lines according to an example of the present disclosure and a comparative example.

### DETAILED DESCRIPTION

The purpose and technical configuration of the present disclosure and the resulting operational effects will be more clearly understood by the following detailed description taken in conjunction with the drawings illustrating embodiments of the present disclosure. Here, since the embodiments of the present disclosure are provided to ensure that the technical spirit of the present disclosure may be sufficiently conveyed to those skilled in the art, the present disclosure may be embodied in other forms without being limited to the following embodiments.

Also, parts denoted by the same reference numerals throughout the specification represent the same components. Furthermore, when the first component is described as being “on” the second component, this includes not only the case where the first component is located on the upper side in direct contact with the second component, but also the case where a third component is located between the first component and the second component.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

Here, terms such as first, second, etc., are used to describe various components and to distinguish one component from another. However, the first component and the second component may be arbitrarily named according to the convenience of those skilled in the art, so long as it does not deviate from the technical spirit of the present disclosure.

The terminology used in the present disclosure is used only to describe certain embodiments and is not intended to be limiting of the present disclosure. For example, a component expressed in the singular includes plural components unless the context clearly indicates that only the singular is intended. Furthermore, it should be understood that terms such as “include” or “have” are intended to specify the presence of a feature, number, step, operation, component, part, or combination thereof described herein, but do not preclude the possibility of the presence or addition of one or more other features, numbers, steps, operations, components, parts, or combinations thereof.

As used herein, the term “intersect” is intended to be interpreted broadly and does not require that two elements physically contact or cross at a single point. The term includes, but is not limited to, configurations in which one element overlaps, traverses across, crosses over, is vertically aligned with, or extends over another element in a plan view or a cross-sectional view. The term may also encompass situations where elements are separated by one or more intervening layers, such as insulating films or dielectric structures. Accordingly, “intersect” should be understood to include relative positional arrangements that result in electrical, optical, or spatial alignment, even in the absence of direct physical contact.

As used herein, the term “connected” is intended to have the broadest possible meaning. Specifically, the phrase “A is connected to B” encompasses both a direct connection—where no intervening components or elements are present—and an indirect connection, where one or more intermediate components or elements exist between A and B. In other words, “A is connected to B” includes both direct physical or electrical coupling and indirect coupling through one or more intervening components. Unless explicitly stated otherwise, these terms do not require direct physical or electrical contact. The terms “coupled” and “in contact” should be interpreted in the same manner.

Also, unless defined otherwise, all terms used herein, including technical or scientific terms, have the same meaning as commonly understood by one of ordinary skill in the art to which the present disclosure pertains. Terms defined in commonly used dictionaries should be interpreted as having a meaning consistent with their meaning in the context of the relevant technology and will not be interpreted in an idealized or overly formal sense unless expressly defined otherwise herein.

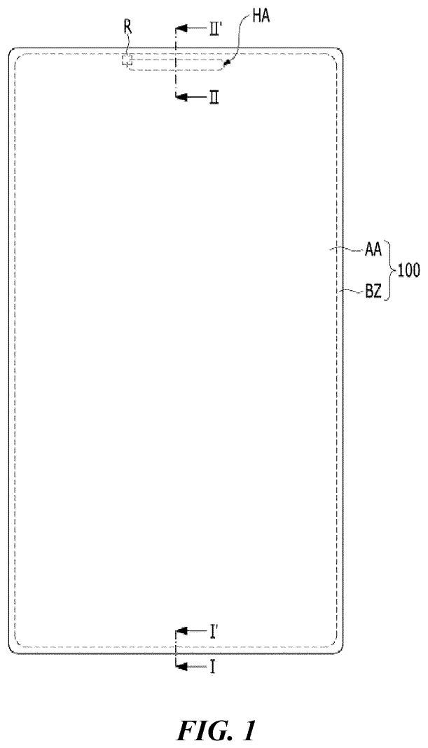

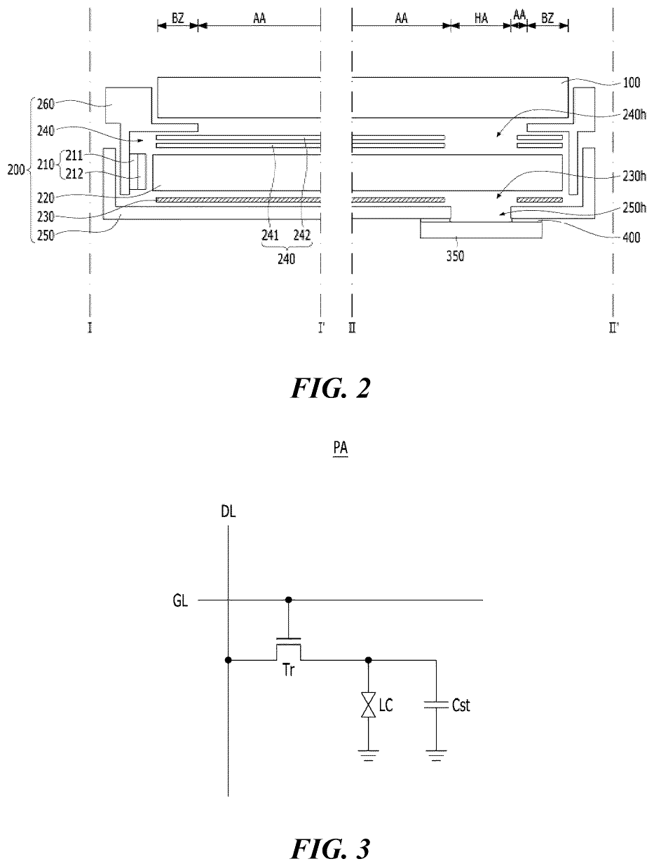

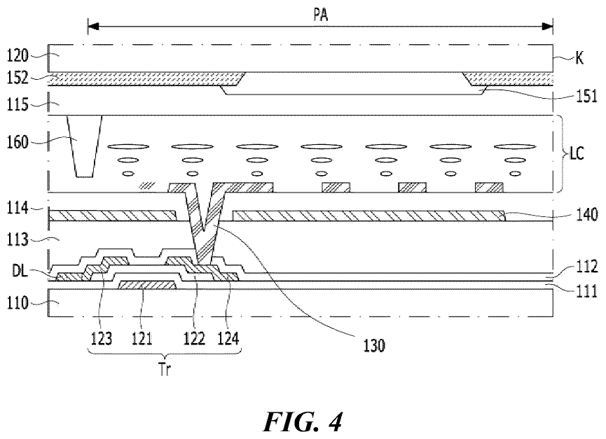

FIG. 1 schematically shows a display apparatus according to an embodiment of the present disclosure. FIG. 2 is a cross-sectional view taken along lines I-I′ and II-II′ of FIG. 1. FIG. 3 shows a circuit of a pixel area located in a liquid crystal display panel in the display apparatus according to an embodiment of the present disclosure. FIG. 4 is a cross-sectional view of a pixel area PA in the active area AA rather than the sensing area.

Referring to FIGS. 1 to 4, the display apparatus according to an embodiment of the present disclosure may include a liquid crystal display panel 100 configured to display an image, a backlight unit 200 located below the liquid crystal display panel 100 and configured to supply light to the liquid crystal display panel 100, and an optical device 350 located below the backlight unit 200 and configured to sense external light through a sensing area HA of the liquid crystal display panel 100.

The liquid crystal display panel 100 may serve to generate images to be provided to the user. For example, the liquid crystal display panel 100 may include an active area AA in which a plurality of pixel areas is located and a bezel area BZ located outside the active area AA. The liquid crystal display panel 100 may include a sensing area HA configured to sense external light or capture an image in the active area AA. The sensing area HA of the liquid crystal display panel 100 may overlap the optical device 350.

The liquid crystal display panel 100 may include a liquid crystal layer overlapping pixel areas. For example, the liquid crystal layer of the liquid crystal display panel 100 may include liquid crystals of IPS (in-plane switching) mode, FFS (fringe field switching) mode, or TN (twisted nematic) mode. Various signals may be applied to each pixel area through signal lines. For example, liquid crystals located in a portion of the liquid crystal layer overlapping each pixel area may be rotated by a vertical or horizontal electric field formed in the pixel area via signal lines. Accordingly, in the display apparatus according to an embodiment of the present disclosure, images of various colors may be generated by light emitted from the active area AA of the liquid crystal display panel 100.

The liquid crystal display panel 100 may include a liquid crystal layer LC located between a first display substrate 110 and a second display substrate 120. The first display substrate 110 and the second display substrate 120 may include an insulating material. The first display substrate 110 and the second display substrate 120 may include a transparent material. For example, the first display substrate 110 and the second display substrate 120 may include glass or plastic. The second display substrate 120 may include a different material from the first display substrate 110. The liquid crystal layer LC may include liquid crystals of various modes. For example, the liquid crystal layer LC may include liquid crystals of IPS mode. The liquid crystals of the liquid crystal layer LC overlapping each pixel area PA may be rotated by a vertical electric field or a horizontal electric field formed in the pixel area PA by the gate signal and the data signal. For example, in each pixel area PA, a pixel electrode 130 forming a horizontal electric field and a common electrode 140 overlapping a portion of the pixel electrode 130 may be located.

A constant power voltage may be supplied to the common electrode 140 of each pixel area PA. The pixel electrode 130 of each pixel area PA may be supplied with a driving voltage corresponding to a data signal applied to the pixel area PA in response to a gate signal applied to the pixel area PA. Specifically, in the display apparatus according to an embodiment of the present disclosure, a horizontal electric field may be formed in each pixel area PA by a driving voltage applied to the pixel electrode 130 of the pixel area PA and a power voltage applied to the common electrode 140. The driving voltage applied to the pixel electrode 130 of each pixel area PA may be maintained for one frame. For example, at least one thin film transistor Tr and storage capacitor Cst may be located in each pixel area PA.

The thin film transistor Tr of each pixel area PA may serve to generate a driving voltage corresponding to a data signal applied to the pixel area PA in response to a gate signal applied to the pixel area PA. The thin film transistor Tr of each pixel area PA may be electrically connected to one of gate lines GL and one of data lines DL. For example, the thin film transistor Tr of each pixel area PA may include a gate electrode 121 electrically connected to one of the gate lines GL, a semiconductor pattern 122 including an area overlapping the gate electrode 121, a drain electrode 123 electrically connected to one end of the semiconductor pattern 122, and a source electrode 124 electrically connected to the remaining end of the semiconductor pattern 122.

The gate electrode 121 may include a conductive material. For example, the gate electrode 121 may include a metal such as aluminum (Al), chromium (Cr), copper (Cu), molybdenum (Mo), titanium (Ti), or tungsten (W). The semiconductor pattern 122 may be located on the gate electrode 121. The semiconductor pattern 122 may include a semiconductor material. For example, the semiconductor pattern 122 may include amorphous silicon (a-Si), polycrystalline silicon (poly-Si), or an oxide semiconductor such as IGZO. The semiconductor pattern 122 may include a channel area located between a drain area and a source area. For example, the gate electrode 121 may overlap the channel area of the semiconductor pattern 122. The drain area and the source area of the semiconductor pattern 122 may be located outside the gate electrode 121.

The drain area and the source area of the semiconductor pattern 122 may have a smaller resistance than the channel area of the semiconductor pattern 122. For example, the drain area and the source area of the semiconductor pattern 122 may include a conductive area of an oxide semiconductor. The channel area of the semiconductor pattern 122 may be a non-conductive area of an oxide semiconductor. The semiconductor pattern 122 may be spaced apart from the gate electrode 121. The semiconductor pattern 122 may be insulated from the gate electrode 121. For example, the channel area of the semiconductor pattern 122 may have electrical conductivity corresponding to the voltage supplied to the gate electrode 121. The drain area of the semiconductor pattern 122 may be electrically connected to the source area of the semiconductor pattern 122 in response to a signal applied to the gate electrode 121.

The drain electrode 123 and the source electrode 124 may include a conductive material. For example, the drain electrode 123 and the source electrode 124 may include a metal such as aluminum (Al), chromium (Cr), copper (Cu), molybdenum (Mo), titanium (Ti), or tungsten (W). The drain electrode 123 and the source electrode 124 may include a different material from the gate electrode 121. For example, the drain electrode 123 and the source electrode 124 may be located on a different layer from the gate electrode 121. The source electrode 124 may be located on the same layer as the drain electrode 123. The source electrode 124 may include the same material as the drain electrode 123. The source electrode 124 may be formed by the same process as the drain electrode 123. For example, the source electrode 124 may be formed concurrently with the drain electrode 123.

The drain electrode 123 may be electrically connected to the drain area of the semiconductor pattern 122. The source electrode 124 may be electrically connected to the source area of the semiconductor pattern 122. The drain electrode 123 and the source electrode 124 may be insulated from the gate electrode 121. The source electrode 124 may be spaced apart from the drain electrode 123. For example, the drain electrode 123 of each pixel area PA may be electrically connected to one of the data lines DL. The drain electrode 123 may be formed integrally with one of the data lines DL. The pixel electrode 130 of each pixel area PA may be electrically connected to the source electrode 124 of the pixel area PA.

The storage capacitor Cst of each pixel area PA is able to maintain a signal applied to the gate electrode 121 of the pixel area PA for one frame. For example, the storage capacitor Cst of each pixel area PA may be electrically connected to the gate electrode 121 of the pixel area PA and a power voltage supply line configured to supply the power voltage.

The thin film transistor Tr and the storage capacitor Cst of each pixel area PA may be located between the first display substrate 110 and the liquid crystal layer LC. A plurality of insulating films 111, 112, 113, 114 may be located between the first display substrate 110 and the liquid crystal layer LC to prevent unnecessary electrical connection. For example, a gate insulating film 111, a device protective film 112, a planarization film 113, and an interlayer insulating film 114 may be located between the first display substrate 110 and the liquid crystal layer LC.

The gate insulating film 111 may be located close to the first display substrate 110. The semiconductor pattern 122 of each pixel area PA may be insulated from the gate electrode 121 of the pixel area PA by the gate insulating film 111. For example, the gate electrode 121 of each pixel area PA may be covered by the gate insulating film 111. The semiconductor pattern 122 of each pixel area PA may be located on the gate insulating film 111. The drain electrode 123 and the source electrode 124 of each pixel area PA may be in direct contact with respective portions of the semiconductor pattern 122 located in the pixel area PA. For example, the drain electrode 123 and the source electrode 124 of each pixel area PA may be located on the gate insulating film 111. The gate insulating film 111 may include an insulating material. For example, the gate insulating film 111 may include an inorganic insulating material such as silicon oxide (SiOx) or silicon nitride (SiNx).

The device protective film 112 may be located on the gate insulating film 111. The device protective film 112 may serve to prevent damage to the thin film transistor Tr located in each pixel area PA due to external impact and moisture. For example, the semiconductor pattern 122, the drain electrode 123, and the source electrode 124 of each pixel area PA may be covered by the device protective film 112. The device protective film 112 may include an insulating material. For example, the device protective film 112 may include an inorganic insulating material such as silicon oxide (SiOx) or silicon nitride (SiNx).

The planarization film 113 may be located on the device protective film 112. The planarization film 113 may serve to eliminate steps caused by the thin film transistor Tr and the storage capacitor Cst of each pixel area PA. For example, the upper surface of the planarization film 113 facing the liquid crystal layer LC may be parallel to the upper surface of the first display substrate 110 facing the liquid crystal layer LC. The planarization film 113 may include an insulating material. The planarization film 113 may include a different material from the device protective film 112. The planarization film 113 may include a material having relatively high fluidity. For example, the planarization film 113 may include an organic insulating material.

The common electrode 140 may be located on the planarization film 113. The interlayer insulating film 114 may be located between the planarization film 113 and the liquid crystal layer LC. The common electrode 140 of each pixel area PA may be insulated from the pixel electrode 130 of the pixel area PA by the interlayer insulating film 114. For example, the common electrode 140 of each pixel area PA may be covered by the interlayer insulating film 114. The pixel electrode 130 of each pixel area PA may be located between the interlayer insulating film 114 and the liquid crystal layer LC. Each pixel electrode 130 may have at least one slit. The interlayer insulating film 114 may include an insulating material. For example, the interlayer insulating film 114 may include an inorganic insulating material.

Color filters 151, a black matrix 152, and an upper protective film 115 may be located between the liquid crystal layer LC and the second display substrate 120. The color filters 151 may overlap the pixel areas PA. For example, each color filter 151 may overlap one of the pixel areas PA. Each color filter 151 may serve to display a certain color using light passing through the liquid crystal layer LC. For example, light passing through each color filter 151 may represent one of red, blue, or green. The black matrix 152 may be located side by side with the color filters 151. For example, an end of each color filter 151 may overlap the black matrix 152. FIG. 4 shows that the end of each color filter 151 overlaps the black matrix 152 and the ends of two adjacent color filters 151 do not overlap on the black matrix 152, but the present disclosure is not limited thereto. The ends of two adjacent color filters 151 may overlap each other on the black matrix 152.

The black matrix 152 may include a material capable of reflecting or absorbing light. For example, light passing through the liquid crystal layer LC of each pixel area PA may be emitted to the outside through the color filter 151 of the pixel area PA located in the area defined by the black matrix 152. Accordingly, in the display apparatus according to an embodiment of the present disclosure, images having various colors may be provided to the user.

The black matrix 152 may overlap the signal lines GL, DL. The thin film transistor Tr and the storage capacitor Cst of each pixel area PA may overlap the black matrix 152. Therefore, in the display apparatus according to an embodiment of the present disclosure, the black matrix 152 may prevent the user from recognizing the signal lines GL, DL and the thin film transistor Tr and the storage capacitor Cst of each pixel area PA. Specifically, in the display apparatus according to an embodiment of the present disclosure, deterioration of the quality of an image recognized by the user due to the signal lines GL, DL and the thin film transistor Tr and the storage capacitor Cst of each pixel area PA may be prevented. The color filters 151 and the black matrix 152 may be covered by the upper protective film 115. The upper protective film 115 may serve to prevent damage to the color filters 151 and the black matrix 152 due to external impact and moisture. The upper protective film 115 may include an insulating material. For example, the upper protective film 115 may include an inorganic insulating material such as silicon oxide (SiOx) or silicon nitride (SiNx).

A spacer 160 may be located between the interlayer insulating film 114 and the upper protective film 115. The spacer 160 may serve to maintain a constant gap between the interlayer insulating film 114 and the upper protective film 115. Accordingly, in the display apparatus according to an embodiment of the present disclosure, the liquid crystal layer LC of each pixel area PA may have the same thickness. Therefore, in the display apparatus according to an embodiment of the present disclosure, light passing through the liquid crystal layer LC of each pixel area PA may have the same optical path. Also, in the display apparatus according to an embodiment of the present disclosure, light passing through the liquid crystal layer LC of each pixel area PA may have the same luminance as light passing through the liquid crystal layer LC of the pixel area PA in which the same horizontal electric field as that of the pixel area PA is formed.

The liquid crystal display panel 100 may be located on a backlight unit 200. The backlight unit 200 may serve to supply light to the liquid crystal display panel 100. For example, the liquid crystal display panel 100 may serve to generate an image to be provided to the user using light supplied from the backlight unit 200. The backlight unit 200 may include a light source device 210, a light guide plate 220, a reflector 230, an optical sheet 240, a cover bottom 250, and a middle frame 260.

The light source device 210 may serve to supply light to the liquid crystal display panel 100 through the light guide plate 220. For example, the light source device 210 may be located at one side of the light guide plate 220. The light source device 210 may include a circuit board 211 and a light source 212 mounted on the circuit board 211. The light source 212 may be a self-emissive device capable of generating and emitting light. For example, the light source 212 may include an LED.

The reflector 230 may be located under the light guide plate 220. For example, the light guide plate 220 may be located between the reflector 230 and the liquid crystal display panel 100. The reflector 230 may include a material capable of reflecting light. For example, the reflector 230 may include a metal such as aluminum (Al) or silver (Ag). Accordingly, in the display apparatus according to an embodiment of the present disclosure, light emitted through the lower surface of the light guide plate 220 may be reflected toward the liquid crystal display panel 100 by the reflector 230. Therefore, in the display apparatus according to an embodiment of the present disclosure, the quantity of light supplied to the liquid crystal display panel 100 may be increased by the backlight unit 200.

The optical sheet 240 may be located between the light guide plate 220 and the liquid crystal display panel 100. Light supplied to the liquid crystal display panel 100 through the light guide plate 220 may have overall uniform luminance due to the optical sheet 240. For example, the optical sheet 240 may have a stack structure of a prism sheet 241 and a diffusion sheet 242.

The backlight unit 200 may include a cover bottom 250 configured to accommodate the light source device 210, the light guide plate 220, the reflector 230, and the optical sheet 240. The cover bottom 250 may include an insulating material. For example, the cover bottom 250 may include a plastic. The cover bottom 250 may include a bottom surface and side walls protruding from the edge of the bottom surface. The reflector 230 may be located between the light guide plate 220 and the bottom surface of the cover bottom 250. The light source device 210, the light guide plate 220, and the optical sheet 240 may be located in the space formed by the side walls of the cover bottom 250. For example, the light source device 210, the light guide plate 220, and the optical sheet 240 may be surrounded by the side walls of the cover bottom 250.

The backlight unit 200 may include a middle frame 260 configured to support the liquid crystal display panel 100. The middle frame 260 may be bonded to the cover bottom 250. For example, the middle frame 260 may include a bonding area extending between the cover bottom 250 and the light guide plate 220. The light source device 210 may be fixed to the bonding area of the middle frame 260. For example, the light source device 210 may be attached to the bonding area of the middle frame 260 by an adhesive member. The middle frame 260 may include a seating area extending between the optical sheet 240 and the liquid crystal display panel 100. The seating area of the middle frame 260 may overlap the edge of the optical sheet 240. For example, the seating area of the middle frame 260 may overlap the bezel area BZ of the liquid crystal display panel 100. The active area AA of the liquid crystal display panel 100 may not overlap the seating area of the middle frame 260. For example, the central area of the optical sheet 240 may be exposed by the middle frame 260. The seating area of the middle frame 260 may be in direct contact with the optical sheet 240. Thus, in the display apparatus according to an embodiment of the present disclosure, movement of the optical sheet 240 may be prevented by the middle frame 260.

The reflector 230 may include a through hole 230h that overlaps the sensing area HA of the liquid crystal display panel 100. The optical sheet 240 may include a sheet hole 240h that overlaps the sensing area HA of the liquid crystal display panel 100. The cover bottom 250 may include a cover hole 250h that overlaps the sensing area HA of the liquid crystal display panel 100.

The optical device 350 may serve to detect external light passing through the sensing area HA of the liquid crystal display panel 100 and the backlight unit 200 or capture an image. For example, the optical device 350 may include at least one of a camera or an IR sensor. The optical device 350 may be located below the backlight unit 200. The optical device 350 may be adhered to the back surface of the cover bottom 250 by an adhesive tape 400, but the present disclosure is not limited thereto. The optical device 350 may be fastened to the back surface of the cover bottom 250 by a fastening member such as a screw or the like.

The structure of the pixel area PA provided in the active area AA of the liquid crystal display panel 100 and the structure of the pixel area PA provided in the sensing area HA may be different from each other, which will be described in detail as follows.

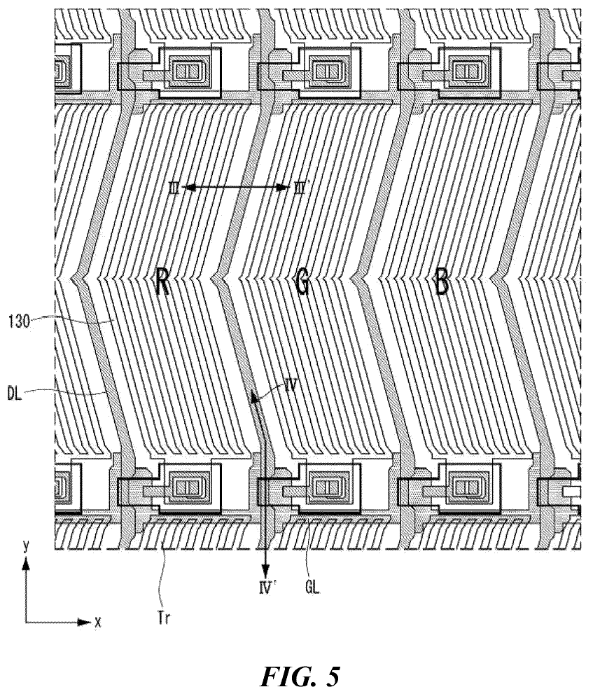

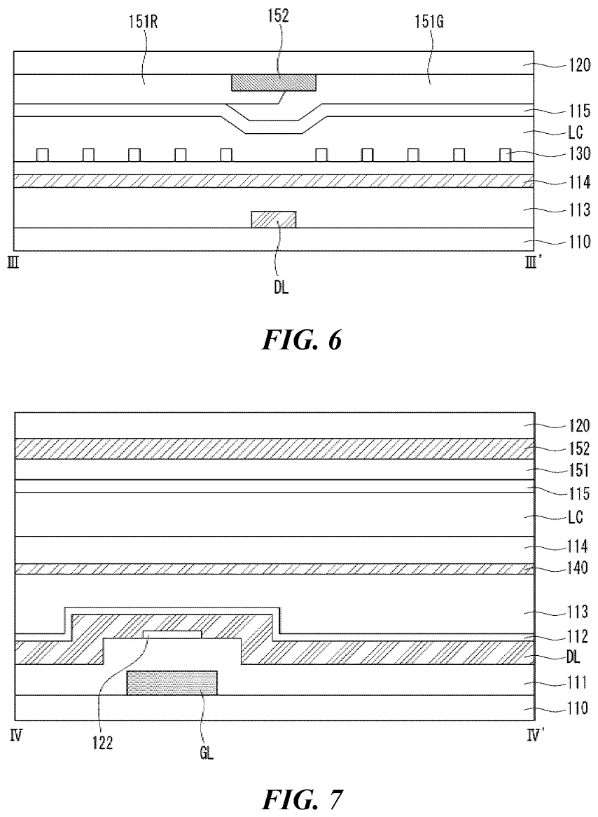

FIG. 5 is a plan view of pixel areas disposed in the active area AA of the liquid crystal display panel according to an embodiment of the present disclosure. FIG. 6 is a cross-sectional view taken along line III-III′ of FIG. 5. FIG. 7 is a cross-sectional view taken along line IV-IV′ of FIG. 5.

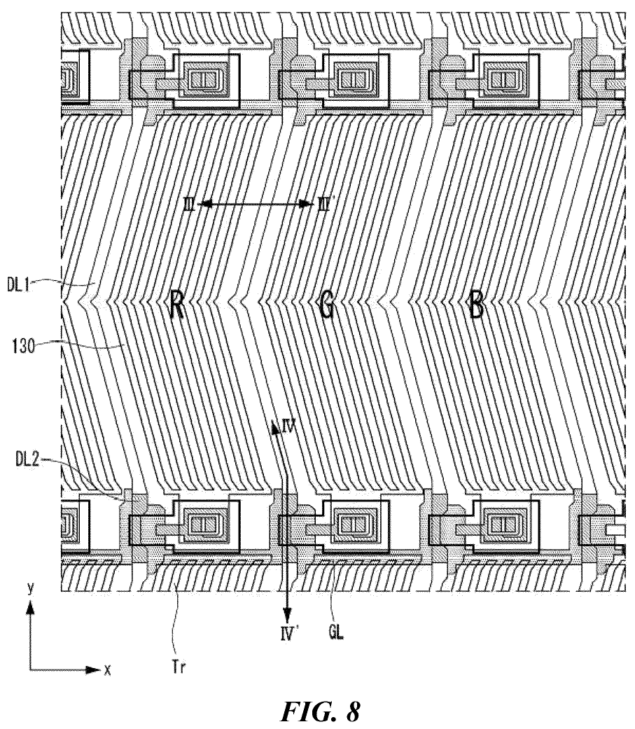

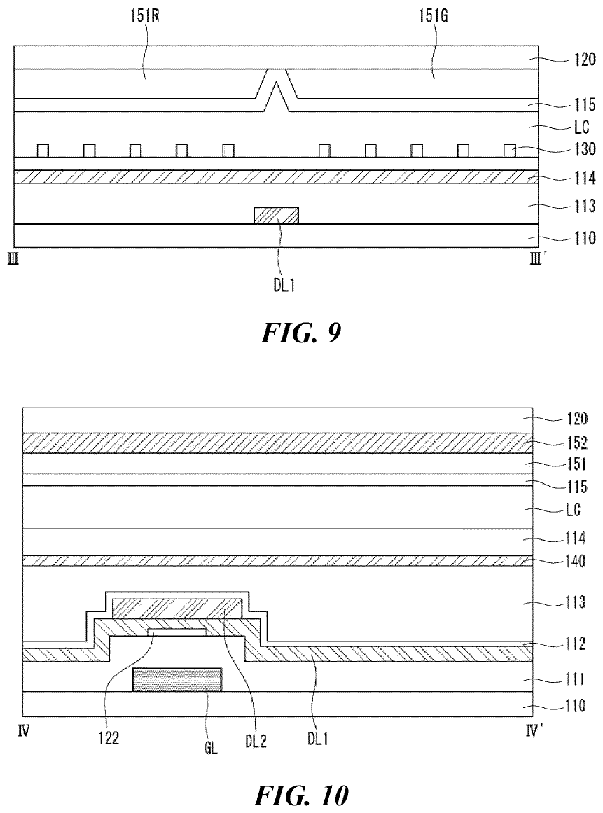

FIG. 8 is a plan view of pixel areas disposed in the sensing area HA of the liquid crystal display panel according to an embodiment of the present disclosure. FIG. 9 is a cross-sectional view taken along line III-III′ of FIG. 8. FIG. 10 is a cross-sectional view taken along line IV-IV′ of FIG. 8.

Since the configuration of the thin film transistor Tr and the pixel electrode 130 is specified in FIG. 4, FIGS. 6 and 7 and FIGS. 9 and 10 mainly illustrate the gate line GL, the data line DL, the pixel electrode 130, the color filters 151, and the black matrix 152. The remaining configuration is as shown in FIG. 4.

As shown in FIGS. 5 to 10, the liquid crystal display panel 100 according to an embodiment of the present disclosure may include a liquid crystal layer LC located between a first display substrate 110 and a second display substrate 120. The liquid crystal display panel 100 has a plurality of pixel areas PA, and the pixel areas PA may include a red pixel area R, a green pixel area G, and a blue pixel area B.

A plurality of gate lines GL and a plurality of data lines DL may be disposed on the first display substrate 110. The gate lines GL may be disposed to extend in a first direction X and the data lines DL may be disposed to extend in a second direction Y, defining a plurality of pixel areas PA. The gate insulating film 111 as described in FIG. 4 may be disposed between the gate lines GL and the data lines DL.

Each pixel area PA may include a thin film transistor Tr disposed at a portion where each gate line GL and each data line DL intersect, and a pixel electrode 130 to which a driving voltage corresponding to a data signal is supplied through the thin film transistor Tr. The pixel electrode 130 may be formed of a transparent conductive material such as ITO or IZO. A common electrode 140 may be disposed below the pixel electrode 130. The pixel electrode 130 and the common electrode 140 may be electrically insulated from each other by an interlayer insulating film 114.

The gate electrode of the thin film transistor Tr may be formed integrally with the gate line GL or electrically connected to the gate line GL. The drain electrode of the thin film transistor Tr may be formed integrally with the data line DL or electrically connected to the data line DL. The source electrode of the thin film transistor Tr may be electrically connected to the pixel electrode 130.

The black matrix 152 and the color filters 151 may be disposed on the second display substrate 120. The black matrix 152 may be disposed to cover the gate lines GL and the data lines DL disposed on the first display substrate 110 and the thin film transistor Tr disposed in each pixel area. The color filters 151 may overlap the pixel areas PA. For example, each color filter 151 may overlap one of the pixel areas PA. The color filters 151 may include a red color filter 151R, a green color filter 151G, and a blue color filter (not shown). An end of each color filter 151 may overlap the black matrix 152. The ends of two adjacent color filters 151 may overlap each other on the black matrix 152. The color filters 151 and the black matrix 152 may be covered by an upper protective film 115.

As shown in FIGS. 5 to 7, in the active area AA of the liquid crystal display panel according to an embodiment of the present disclosure, all data lines DL may be formed of an opaque metal material such as aluminum (Al), chromium (Cr), copper (Cu), molybdenum (Mo), titanium (Ti), or tungsten (W).

On the other hand, as shown in FIGS. 8 to 10, in the sensing area HA of the liquid crystal display panel according to an embodiment of the present disclosure, all data lines DL may be partially formed of a transparent conductive material such as ITO or IZO and a metal material such as aluminum (Al), chromium (Cr), copper (Cu), molybdenum (Mo), titanium (Ti), or tungsten (W). The data lines DL disposed in the active area AA excluding the sensing area HA may comprise a metal material, and the data lines DL disposed in the sensing area HA may comprise a transparent conductive material. Each data line DL disposed in the sensing area HA may comprise the transparent conductive material in an area excluding an area intersecting each gate line GL and may comprise the metal material in the area intersecting each gate line GL. For example, all data lines DL may include a first data line DL1 formed of a transparent conductive material such as ITO or IZO, and a second data line DL2 formed of a metal material such as aluminum (Al), chromium (Cr), copper (Cu), molybdenum (Mo), titanium (Ti), or tungsten (W) on the first data line DL1 in an area where the gate line GL and the first data line DL1 overlap. The second data line DL2 may be in direct contact with the first data line DL1. As shown in FIG. 10, the first data line DL1 may be located on the gate line GL with the gate insulating film 111 interposed therebetween.

In addition, as shown in FIGS. 5 to 7, in the active area AA of the liquid crystal display panel according to an embodiment of the present disclosure, the black matrix 152 may be disposed on the second display substrate 120 to cover the gate lines GL and the data lines DL disposed on the first display substrate 110 and the thin film transistor Tr disposed in each pixel area.

On the other hand, as shown in FIGS. 8 to 10, in the sensing area HA of the liquid crystal display panel according to an embodiment of the present disclosure, the black matrix 152 may not be disposed in a portion excluding an area where the gate lines GL and the data lines DL overlap. For example, the black matrix 152 may be disposed only in an area where the gate lines GL and the data lines DL overlap.

In addition, as shown in FIG. 9, in the sensing area HA of the liquid crystal display panel according to an embodiment of the present disclosure, the ends of two adjacent color filters 151 may not overlap each other in an area where the black matrix 152 is not disposed.

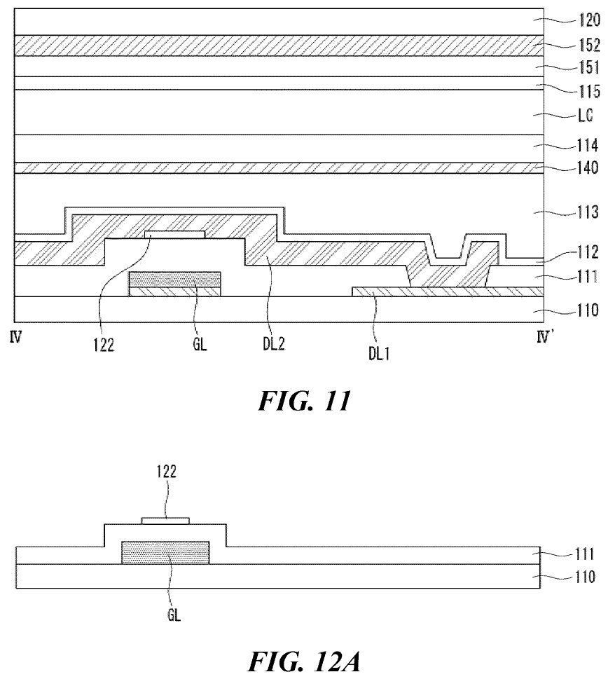

FIG. 11 is a cross-sectional view taken along line IV-IV′ of FIG. 8 according to another embodiment of the present disclosure.

Although providing all data lines DL including the first data line DL1 formed of a transparent conductive material and the second data line DL2 formed of a metal material on the first data line DL1 so as to be in direct contact with the first data line DL1 in an area where the gate line GL and the first data line DL1 overlap is described in FIG. 10, the present disclosure is not limited thereto.

For example, as shown in FIG. 11, a first data line DL1 formed of a transparent conductive material such as ITO or IZO may be provided in an area excluding an area where the gate line GL and the data line DL overlap. Also, in the area where the gate line GL and the data line DL overlap, a second data line DL2 may be formed of a metal material such as aluminum (Al), chromium (Cr), copper (Cu), molybdenum (Mo), titanium (Ti), or tungsten (W) to electrically connect adjacent first data lines DL1. As shown in FIG. 11, the first data line DL1 may be located on the same layer as the gate line GL, and the second data line DL2 may be located on the gate line GL with the gate insulating film 111 interposed therebetween.

As described in FIGS. 8 to 11, according to an embodiment of the present disclosure, the data lines DL in the sensing area HA of the liquid crystal display panel are formed of a transparent conductive material, and the black matrix is not formed in the sensing area HA of the liquid crystal display panel, so that the transmittance of the sensing area HA may be improved. In addition, since the transmittance of the sensing area HA is improved, the recognition rate of the optical device may be increased.

As described in FIGS. 8 to 11, in the sensing area HA of the liquid crystal display panel according to an embodiment of the present disclosure, even when all data lines DL are partially formed of a transparent conductive material and a metal material, a separate mask process may not be added.

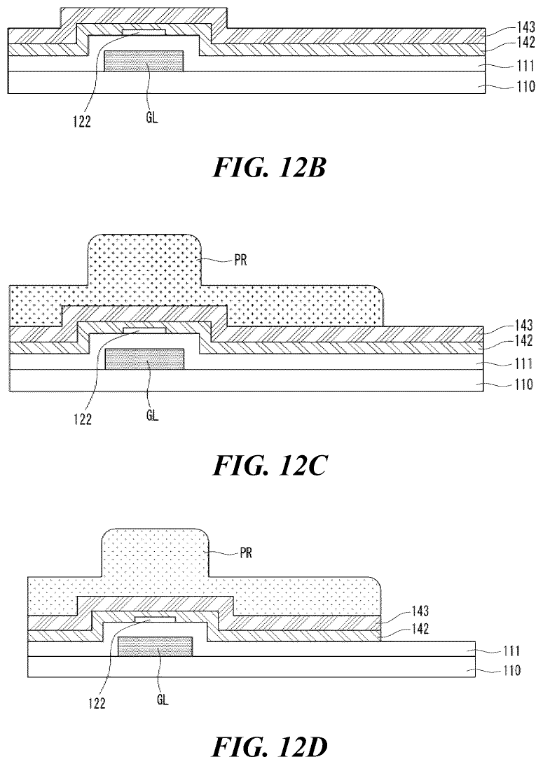

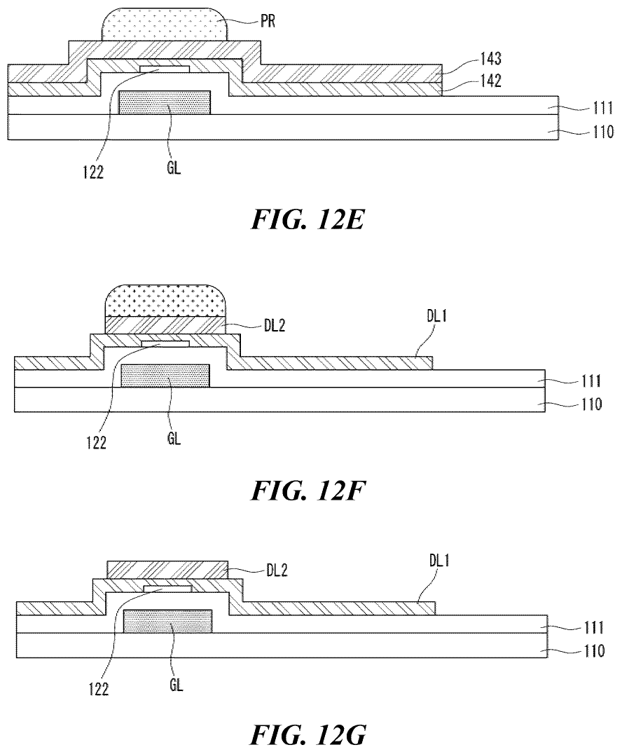

FIGS. 12A to 12G are cross-sectional views of a process of forming data lines DL in the sensing area HA of the liquid crystal display panel according to an embodiment of the present disclosure described in FIGS. 8 to 10.

As shown in FIG. 12A, a gate line GL extending in a first direction X may be formed on a first display substrate 110. The gate line GL may be a gate electrode of a thin film transistor. A gate insulating film 111 may be formed on the front surface of the first display substrate 110 including the gate line GL. A semiconductor pattern 122 may be formed on the gate insulating film 111 on the gate line GL corresponding to the gate electrode of the thin film transistor.

As shown in FIG. 12B, a transparent conductive material layer 142 made of ITO or IZO and a metal material layer 143 made of aluminum (Al), chromium (Cr), copper (Cu), molybdenum (Mo), titanium (Ti), or tungsten (W) may be sequentially formed on the front surface of the first display substrate 110 formed as above.

As shown in FIG. 12C, a photoresist may be formed on the metal material layer 143, and a photoresist pattern PR may be formed through exposure and development processes using a halftone mask. The photoresist pattern PR may be patterned so as to remain only in an area where data lines DL are to be disposed. The photoresist pattern PR may be patterned so that the thickness of the photoresist pattern PR in an area where a second data line DL2 is to be disposed is greater than the thickness of the photoresist pattern PR in an area where a first data line DL1 is to be disposed.

As shown in FIG. 12D, the transparent conductive material layer 142 and the metal material layer 143 may be removed using the photoresist pattern PR as a mask. Accordingly, the first data line DL1 may be formed from the transparent conductive material layer 142.

As shown in FIG. 12E, the photoresist pattern PR is removed through an ashing process so as to remain only at a location where the second data line DL2 is to be formed.

As shown in FIG. 12F, the metal material layer 143 may be removed using the photoresist pattern PR as a mask. Accordingly, the second data line DL2 may be formed from the metal material layer 143.

As shown in FIG. 12G, the photoresist pattern PR is completely removed.

As described in FIGS. 12A to 12G, the first data line DL1 may be formed using a conductive material on the gate insulating film 111 in a direction intersecting the gate line GL and the second data line DL2 may be formed using a metal material so as to be in contact with the first data line DL1 in an area wherein the first data line DL1 intersects the gate line GL, and even when all data lines DL are partially formed of a transparent conductive material and a metal material, a separate mask process may not be added.

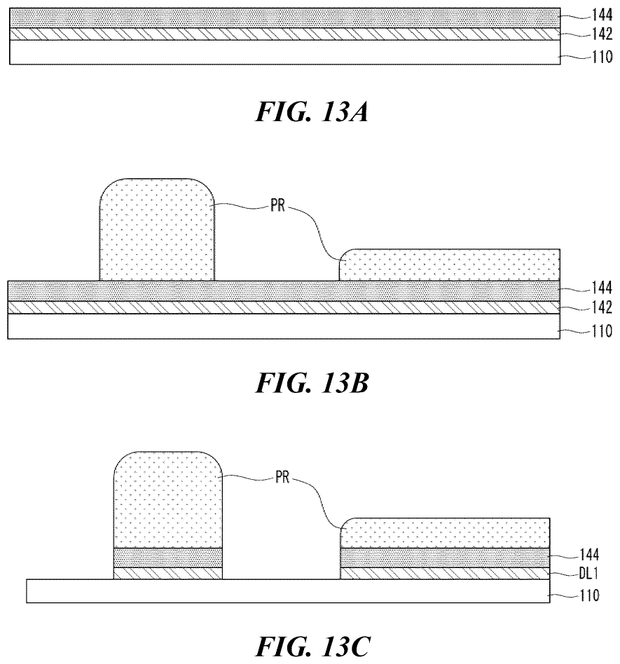

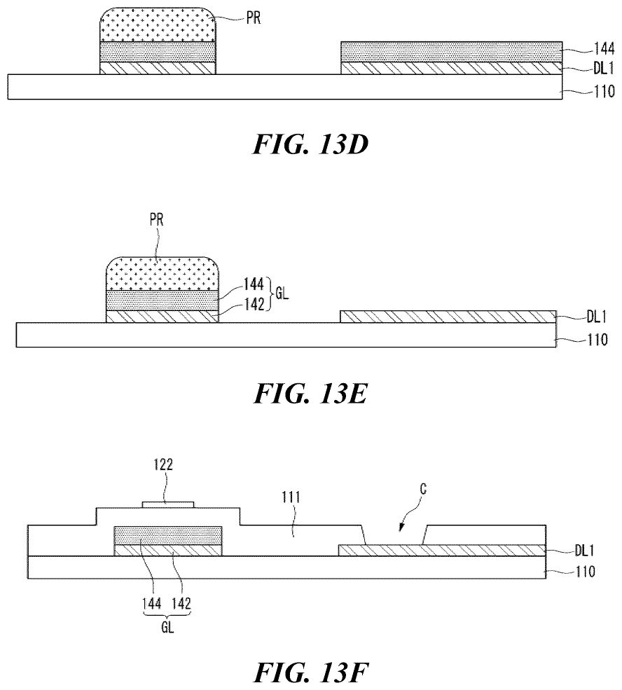

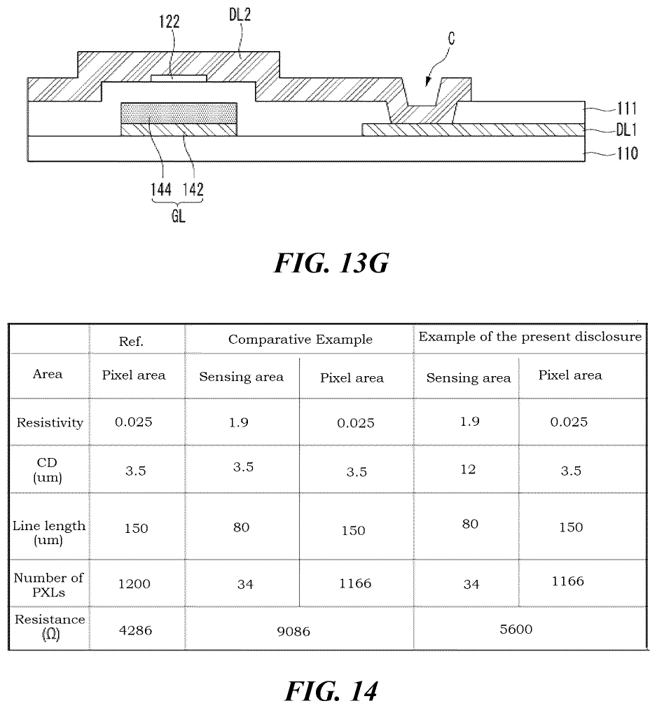

Meanwhile, FIGS. 13A to 13G are cross-sectional views of a process of forming data lines DL in the sensing area HA of the liquid crystal display panel according to another embodiment of the present disclosure described in FIG. 11.

As shown in FIG. 13A, a transparent conductive material layer 142 made of ITO or IZO and a metal material layer 144 made of aluminum (Al), chromium (Cr), copper (Cu), molybdenum (Mo), titanium (Ti), or tungsten (W) may be sequentially formed on the front surface of a first display substrate 110.

As shown in FIG. 13B, a photoresist may be formed on the metal material layer 144, and a photoresist pattern PR may be formed through exposure and development processes using a halftone mask. The photoresist pattern PR may be patterned so as to remain only in an area where a gate line GL and a first data line DL1 are to be disposed. The photoresist pattern PR may be patterned so that the thickness of the photoresist pattern PR in an area where the gate line GL is to be disposed is greater than the thickness of the photoresist pattern PR in an area where the first data line DL1 is to be disposed.

As shown in FIG. 13C, the transparent conductive material layer 142 and the metal material layer 144 may be removed using the photoresist pattern PR as a mask. Accordingly, the first data line DL1 may be formed from the transparent conductive material layer 142. The first data line DL1 may extend in the second direction Y.

As shown in FIG. 13D, the photoresist pattern PR is removed through an ashing process so as to remain only at a location where the gate line GL is to be formed.

As shown in FIG. 13E, the metal material layer 144 located on the first data line DL1 may be removed using the ashed photoresist pattern PR as a mask. Accordingly, the gate line GL may be formed from the metal material layer 144. The gate line GL may have a stack structure of the transparent conductive material layer 142 and the metal material layer 144. The gate line GL may extend in the first direction X. The gate line GL may be a gate electrode of a thin film transistor.

As shown in FIG. 13F, after complete removal of the photoresist pattern PR, a gate insulating film 111 may be formed on the front surface of the first display substrate 110 including the gate line GL and the first data line DL1. A semiconductor pattern 122 may be formed on the gate insulating film 111 on the gate line GL corresponding to the gate electrode of the thin film transistor.

Also, a contact hole C may be formed in the gate insulating film 111 so that both ends of the first data line DL1 are exposed.

As shown in FIG. 13G, a second data line DL2 may be formed on the gate insulating film 111 including the semiconductor pattern 122 using a metal material such as aluminum (Al), chromium (Cr), copper (Cu), molybdenum (Mo), titanium (Ti), or tungsten (W). The second data line DL2 may intersect the gate line GL. The second data line DL2 may serve to electrically connect adjacent first data lines DL1 through the contact hole C formed in the gate insulating film 111.

As described in FIGS. 13A to 13G, even when all data lines DL are partially formed of a transparent conductive material and a metal material, a separate mask process may not be added.

FIG. 14 is a graph showing the resistance of data lines according to an example of the present disclosure and a comparative example.

As described above, even when the data line in the sensing area is formed of a transparent conductive material, no major problem in data driving may occur.

As shown in FIG. 14, when the line width CD of the data line made of the transparent conductive material disposed in the sensing area is formed to be identical to the line width CD of the data line made of the opaque metal layer disposed in the pixel area, the resistance of the data line formed of the transparent conductive material disposed in the sensing area may greatly increase.

However, when the line width CD of the data line made of the transparent conductive material disposed in the sensing area is formed to be greater than the line width CD of the data line made of the opaque metal layer disposed in the pixel area, the resistance of the data line made of the transparent conductive material disposed in the sensing area may not increase greatly.

For example, as in a reference example (Ref), when the line width CD of the data line made of the opaque metal layer disposed in the pixel area is set to 3.5 μm, the resistance of the data line is about 4286 Ω.

However, when both the line width CD of the data line made of the transparent conductive material disposed in the sensing area and the line width CD of the data line made of the opaque metal layer disposed in the pixel area are equally set to 3.5 μm, the resistance of the data line is approximately doubled to about 9086 Ω.

However, when the line width CD of the data line made of the transparent conductive material disposed in the sensing area is set to 12 μm and the line width CD of the data line made of the opaque metal layer disposed in the pixel area is set to 3.5 μm as in a comparative example, the resistance of the data line is about 5600 Ω, which may be regarded as similar to that of a reference example.

Therefore, in embodiments of the present disclosure, when increasing the line width CD of the first data line made of the transparent conductive material disposed in the sensing area, a sufficient data voltage may be supplied to each pixel.

The following paragraphs describe additional embodiments of the display apparatus disclosed herein.

In certain embodiments, a display apparatus includes a liquid crystal display panel comprising a first display substrate 110 and a second display substrate 120 facing the first display substrate 110. A liquid crystal layer LC is disposed between the first and second display substrates. The liquid crystal display panel includes an active area having a plurality of pixel areas defined by a plurality of gate lines GL extending in a first direction and a plurality of data lines DL extending in a second direction intersecting the first direction. A sensing area is disposed within the active area. A gate insulating film 111 is disposed on the first display substrate and covers the gate lines. A plurality of first data lines DL1 is disposed in the sensing area and extends in the second direction on the gate insulating film 111. Each first data line DL1 comprises a transparent conductive material, such as indium tin oxide (ITO) or indium zinc oxide (IZO). A plurality of second data lines DL2 is also disposed in the sensing area and comprises a metal material, such as aluminum (Al), chromium (Cr), copper (Cu), molybdenum (Mo), titanium (Ti), or tungsten (W). The display apparatus further includes a backlight unit 200 located below the liquid crystal display panel 100, and an optical device 350 disposed below the backlight unit 200 and overlapping the sensing area HA.

In some embodiments, each second data line is disposed in an area where the corresponding first data line intersects one of the gate lines and is in direct contact with the corresponding first data line. The second data lines may be disposed in regions aligned with the intersections between the first data lines and the gate lines to provide low-resistance bridging connections.

In certain configurations, each second data line is disposed over a corresponding gate line, with the gate insulating film 111 interposed between the second data line and the gate line. This layered arrangement allows electrical insulation between the gate lines and the second data lines while preserving vertical alignment at the intersection regions.

The first data lines in the sensing area may have a width greater than that of the data lines disposed in the active area outside the sensing area. This increased line width can reduce the electrical resistance of the transparent conductive material and ensure sufficient data signal transmission in the sensing area.

In some embodiments, the second data lines are disposed only in regions where the first data lines intersect the gate lines. Outside the intersection areas, the data lines in the sensing area may consist solely of the transparent conductive material to increase or maximize optical transmittance.

The display apparatus may further include a black matrix 152 disposed on the second display substrate 120 in the active area excluding the sensing area. The black matrix 152 may be aligned to block light from undesired regions and enhance image contrast in the active area.

In certain embodiments, the black matrix 152 is omitted entirely in the sensing area. The absence of a black matrix 152 in the sensing area improves light transmittance toward the optical device located below the display panel.

The black matrix 152 may be aligned to cover regions where the gate lines and the data lines intersect in the active area excluding the sensing area. This alignment may prevent visibility of signal lines and enhance contrast without obstructing the sensing function.

In some embodiments, the black matrix 152 is not disposed over any portion of the sensing area that does not correspond to a gate line or a data line. The black matrix 152 may be disposed only at intersections between the gate lines and the data lines in the sensing area of the liquid crystal display panel. This structure reduces or minimizes interference with light transmission in the sensing area while optionally preserving partial masking at signal line crossings.

The display apparatus may also include a plurality of color filters disposed on the second display substrate 120. In the sensing area, the ends of adjacent color filters may be spaced apart without overlapping. This configuration reduces the accumulation of optical layers and enhances the clarity of light transmission through the sensing region.

In other embodiments, the display apparatus includes a plurality of color filters and a black matrix disposed on the second display substrate 120 in the active area excluding the sensing area. In the active area outside the sensing area, the ends of adjacent color filters may overlap each other on the black matrix. This structure maintains color purity and prevents light leakage between adjacent subpixels in the image display area.

In certain configurations, the optical device 350 is disposed to receive external light through the sensing area without interference from the black matrix or the plurality of second data lines. In these cases, the structural arrangement of the sensing area, including the use of transparent conductive material and omission of opaque elements, enhances the recognition rate of the optical device.

The display apparatus may further comprise a thin film transistor in each pixel area, the thin film transistor including a gate electrode formed integrally with one of the gate lines and a drain electrode formed integrally with one of the first data lines.

As is apparent from the foregoing, a display apparatus and a method of manufacturing a liquid crystal display panel according to the technical spirit of the present disclosure have the following effects.

First, since data lines in the sensing area of the liquid crystal display panel are formed of a transparent conductive material and a black matrix is not formed in the sensing area of the liquid crystal display panel, the transmittance of the sensing area can be improved. Furthermore, since the transmittance of the sensing area HA is improved, the recognition rate of an optical device can be increased.

Second, in the sensing area of the liquid crystal display panel, process optimization can be achieved because a separate mask process is not added even when all data lines are partially formed of a transparent conductive material and a metal material.

The effects according to the embodiments are not limited to the foregoing, and more diverse effects are included in the present disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display apparatus, comprising:
a liquid crystal display panel comprising an active area in which a plurality of pixel areas is defined by a plurality of gate lines and a plurality of data lines intersecting each other and a bezel area located outside the active area, in which the active area has a sensing area;
a backlight unit located below the liquid crystal display panel; and
an optical device configured to detect external light passing through the sensing area of the liquid crystal display panel or capture an image,
wherein the data lines disposed in the active area excluding the sensing area comprise a metal material, and the data lines disposed in the sensing area comprise a transparent conductive material.

2. The display apparatus according to claim 1, wherein each data line disposed in the sensing area comprises the transparent conductive material in an area excluding an area intersecting each gate line and comprises the metal material in the area intersecting each gate line.

3. The display apparatus according to claim 2, wherein each data line disposed in the sensing area comprises:
a first data line having the transparent conductive material, and
a second data line having the metal material on the first data line so as to be in direct contact with the first data line in the area where the first data line intersects the gate lines.

4. The display apparatus of claim 3, wherein a width of the first data lines in the sensing area is greater than a width of the data lines disposed in the active area outside the sensing area.

5. The display apparatus according to claim 2, wherein each data line disposed in the sensing area comprises;
a first data line having the transparent conductive material disposed in the area excluding the area intersecting each gate line, and
a second data line disposed in the area intersecting each gate line, electrically connecting adjacent first data lines, and comprising the metal material.

6. The display apparatus of claim 5, wherein a width of the first data lines in the sensing area is greater than a width of the data lines disposed in the active area outside the sensing area.

7. The display apparatus according to claim 5, further comprising;
a gate insulating film covering the plurality of gate lines,
wherein the first data line is disposed on the same layer as the plurality of gate lines, and
wherein the second data line is disposed on the gate insulating film.

8. The display apparatus according to claim 1, further comprising a black matrix disposed in the active area excluding the sensing area of the liquid crystal display panel,
wherein the black matrix is not disposed in the sensing area of the liquid crystal display panel.

9. The display apparatus of claim 8, wherein the black matrix is aligned to cover regions where the gate lines and the data lines intersect in the active area excluding the sensing area.

10. The display apparatus according to claim 1, further comprising a black matrix disposed only at intersections between the gate lines and the data lines in the sensing area of the liquid crystal display panel.

11. The display apparatus of claim 10, wherein the black matrix is not disposed over any portion of the sensing area that does not correspond to a gate line or a data line.

12. The display apparatus of claim 8, wherein the optical device, in operation, receives external light through the sensing area without interference from the black matrix.

13. The display apparatus according to claim 8, further comprising a color filter layer disposed in each pixel area,
wherein ends of adjacent color filter layers do not overlap each other in the sensing area of the liquid crystal display panel.

14. The display apparatus according to claim 13, wherein the ends of adjacent color filter layers overlap each other in the active area excluding the sensing area of the liquid crystal display panel.

15. The display apparatus of claim 1, further comprising a thin film transistor including a gate electrode formed integrally with one of the plurality of gate lines and a drain electrode formed integrally with one of the plurality of data lines.

16. A method of manufacturing a liquid crystal display panel comprising an active area in which a plurality of pixel areas is defined by a plurality of gate lines and a plurality of data lines intersecting each other and a bezel area located outside the active area, in which the active area has a sensing area, comprising:
forming a gate line having a gate electrode on a substrate in the sensing area;
forming a gate insulating film on the substrate comprising the gate line;
forming a semiconductor pattern on the gate insulating film on the gate electrode; and
forming a first data line using a conductive material on the gate insulating film in the sensing area in a direction intersecting the gate line and a second data line using a metal material so as to be in contact with the first data line in an area wherein the first data line intersects the gate line.

17. The method according to claim 16, wherein forming the first data line and the second data line comprises:
sequentially forming a transparent conductive material layer and a metal material layer on the gate insulating film,
forming a photoresist pattern having a higher thickness in an area where the second data line is to be disposed compared to an area where the first data line is to be disposed, using a halftone mask,
removing the transparent conductive material layer and the metal material layer using the photoresist pattern as a mask to form the first data line,
ashing the photoresist pattern so as to remain only at a location where the second data line is to be formed, and
forming the second data line by removing the metal material layer using the ashed photoresist pattern as a mask.

18. A method of manufacturing a liquid crystal display panel comprising an active area in which a plurality of pixel areas is defined by a plurality of gate lines and a plurality of data lines intersecting each other and a bezel area located outside the active area, in which the active area has a sensing area, comprising:
forming a gate line having a gate electrode extending in a first direction on a substrate in the sensing area and a plurality of first data lines using a conductive material in a direction intersecting the gate line in the sensing area;
forming a gate insulating film on the substrate comprising the gate line and the first data lines;
forming a semiconductor pattern on the gate insulating film on the gate electrode; and
forming a second data line using a metal material on the gate insulating film in a direction intersecting the gate line so as to electrically connect adjacent first data lines.

19. The method according to claim 18, wherein forming the gate line and the first data lines comprises:
sequentially forming a transparent conductive material layer and a metal material layer on the substrate,
forming a photoresist pattern having a higher thickness in an area where the gate line is to be disposed than an area where the first data lines are to be disposed, using a halftone mask, in the area where the first data lines are to be disposed and the area where the gate line is to be disposed;
removing the transparent conductive material layer and the metal material layer using the photoresist pattern as a mask to form the first data lines,
ashing the photoresist pattern so as to remain only at a location where the gate line is to be formed; and
forming the gate line by removing the metal material layer using the ashed photoresist pattern as a mask.
